(19) United States
(12) Patent Application Publication
(10) Pub. No.: US 2005/0278757 A1
(43) Pub. Date: Dec. 15, 2005

(54) Downloadable watch faces

(75) Inventors: Joel K. Grossman, Seattle, WA (US); Albert W. Tan, Redmond, WA (US); Paul J. VanderSpek, Seattle, WA (US); Roger E. Wolff, Sammamish, WA (US); Roger Colin Miller, Sammamish, WA (US); Christian James Colando, Seattle, WA (US)

Correspondence Address: MICROSOFT CORPORATION;C/O MERCHANT & GOULD, L.L.C., P.O. BOX 2903, MINNEAPOLIS, MN, 55402-0903, US

(73) Assignee: Microsoft Corporation, Redmond, WA (US)

(21) Appl. No.: 10/857,398

(22) Filed: May 28, 2004

(51) Int. Cl. H04N 7/173; H04N 7/16; G06F 13/00; H04N 5/445

(52) U.S. Cl. 725/87; 725/62; 725/37; 715/530

(57) ABSTRACT

The present invention downloads watch faces to a mobile electronic device. Watch faces are broadcast to mobile electronic devices. The watch faces are automatically delivered and stored on a mobile electronic device for selection by a user. Using the device, users can quickly change the current watch face. The user may customize the watch faces they receive. For example, the user may select from a list of available watch faces. Additionally, a mystery watch face may be communicated to the device.

### BACKGROUND OF THE INVENTION

Mobile electronic devices, such as cell phones, wireless PDAs, wireless laptops and other mobile communication devices are making impressive inroads with consumers. Many of the mobile electronic devices are able to perform a variety of tasks and include a user interface to help the user access the features associated with the device. For example, some mobile devices include a display unit that displays graphical data to support email, instant messaging, web browsing, and other non-voice features. Using their mobile devices, users access the Internet, send and receive email, participate in instant messaging, and perform other operations. Accessing the desired information and customizing their devices, however, may be cumbersome for the user.

### SUMMARY OF THE INVENTION

The present invention is directed at downloading watch faces to a mobile electronic device.

According to one aspect of the invention, watch faces are broadcast to mobile electronic devices. The watch faces are automatically delivered and stored on a mobile electronic device for selection by a user. Using the device, users can quickly change the current watch face.

According to another aspect of the invention, the user may customize the watch faces they receive. For example, the user may select from a list of available watch faces. Additionally, a mystery watch face may be communicated to the device.

A more complete appreciation of the present invention and its improvements can be obtained by reference to the accompanying drawings, which are briefly summarized below, to the following detailed description of illustrative embodiments of the invention, and to the appended claims.

### BRIEF DESCRIPTION OF THE DRAWINGS

FIG. 1 illustrates an operating environment;

FIG. 2 shows an electronic device;

FIG. 3 illustrates an exemplary smart object watch devices that include a user interface for navigating through channels and content;

FIG. 4 illustrates a system for delivering and configuring channel information to an electronic device;

FIG. 5 illustrates operating modes for a time channel;

FIG. 6 illustrates a face mode;

FIG. 7 illustrates a user interface for managing watch faces;

FIG. 8 illustrates a user adding a watch face;

FIG. 9 illustrates hovering over a preview watch face icon;

FIG. 10 illustrates subscribing to a mystery watch face;

FIG. 11 illustrates an exemplary display showing that memory is full;

FIG. 12 illustrates ROM faces and downloadable watch faces;

FIG. 13 illustrates purchasing watch faces;

FIG. 14 illustrates another user interface for managing watch faces; and

FIG. 15 illustrates a process flow for receiving a new watch face, in accordance with aspects of the present invention.

### DETAILED DESCRIPTION OF THE PREFERRED EMBODIMENT

The apparatus, system, and method of the present invention are related to downloadable watch faces. Content that is associated with a time channel, that includes a watch face mode, may be selected and viewed on a display of the device by means of passive interaction (e.g., hands free operation) or active interaction (e.g., selecting buttons).

In the described embodiments, the electronic devices may be mobile devices, such as smart watches, that are specially configured to receive communication signals. The electronic devices may be configured to receive broadcast transmissions from one or more broadcast towers and are capable of receiving and processing messages from the broadcast transmissions. The electronic devices store the received information such that the information is indexed according to designated channels. Each channel includes content that is organized according to a set of criteria. For example, watch face content is presented in one channel; wherein movie content is presented in another channel. Some channels may include content from one or more of the other channels. After information is received and processed by the client device, a user may passively or actively review the information that is stored in the electronic device.

One of the particular channels allows a user to receive watch faces. The watch faces received on each device may be customized based on user preferences such that the user experience is enhanced. The content downloaded by the device includes program code relating to the functionality of the watch face and may also include a graphic image.

Although described here in the context of a watch-based system, other mobile or non-mobile devices, such as portable and desktop computers, personal digital assistants (PDAs), cellular telephones, and the like, may be used. The use of a watch is for illustrative purposes only to simplify the following discussion, and may be used interchangeably with “mobile device” and/or “electronic device”.

The term “content” can be any information that may be stored in an electronic device. By way of example, and not limitation, content may comprise graphical information, textual information, and any combination of graphical and textual information. Content may be displayable information or auditory information. Auditory information may comprise a single sound or a stream of sounds.

Exemplary Smart Object Device

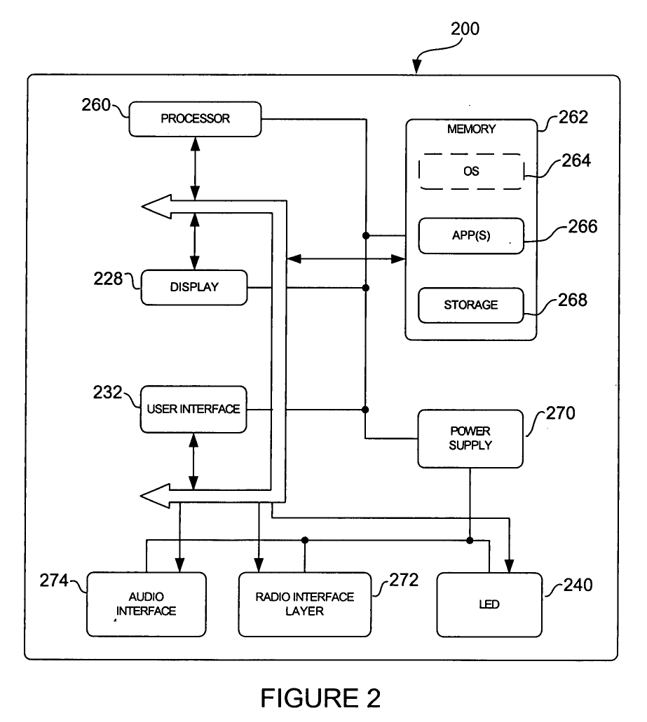

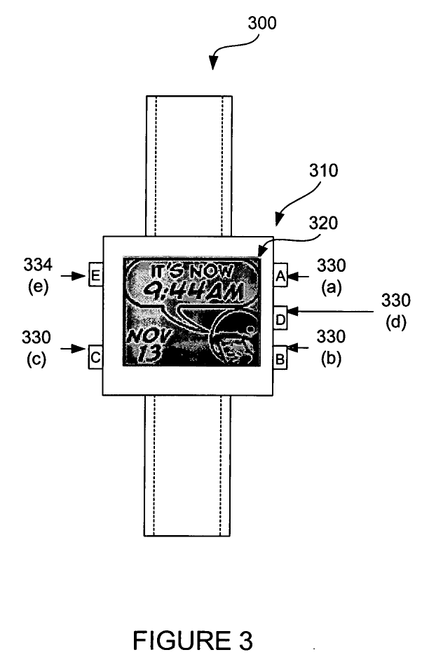

FIG. 3 illustrates an exemplary smart device that includes a user interface that is configured to interact with content from channels, in accordance with aspects of the invention. Watch device 300 includes bezel 310 which has an electronic system. The electronic system performs the functions in a manner that is consistent with the hardware that is described with respect to FIG. 2. Bezel 310 includes display 320, such as a liquid crystal display, a multiple bit display, or a full color display. As illustrated, display 320 shows an exemplary downloadable watch face that shows the time and date.

Watch device 300 includes a series of selectors, such as buttons A-D (330a-d), which are arranged to operate as part of a user interface (UI). Each selector may have a default function and/or a context determined function. The currently selected channel determines the context for each selector. Alternatively, the currently active display may determine the context for each selector. For example, a display screen (e.g., a help screen) may be superimposed on the main display such that the display screen becomes the active context. Watch device 300 is context sensitive in that the function that is associated with each selector may change based on the selected channel or display screen.

Button “A” has a default function of page up or previous page in the currently selected channel. Button “A” may also have an alternate function based on the currently selected channel or display. For example, button “A” may be configured to activate a speed list browse function after button “A” is activated for a predetermined time interval. In the speed list browse function, a pop-up visual cue (e.g., a pop-up window) may be used to indicate how that list is indexed. Each record (e.g., a list of watch faces, etc.) can be indexed many different ways, including alphabetically, by date, categories, or any other way of indexing a record. List browse indexing allows a user to quickly access records located within the list.

Button “B” has a default function of page down or next page in the currently selected channel. Button “B” may also have an alternate function based on the currently selected channel or display. In one example, button “B” is activated for a predetermined time interval (e.g., two seconds) to select a “speed list browse” function.

Button “C” has a default function of next channel. Button “C” may also have an alternate function based on the currently selected channel or display. In one example, button “C” is activated for a predetermined time interval (e.g., two seconds) to select the main channel or “primary” channel. The main channel in an example watch device is the time channel that provides the user with time related information. However, devices may be configured to have some other display screen that is recognized by the device as a “primary” channel or “home” location.

Button “D” has a default (or “primary”) function of “enter.” The “enter” function is context sensitive and used to select the “enter” function within a selected channel (e.g., enter the faces mode), or to select an item from a selection list (e.g., select a particular watch face). Button “D” may also have an alternate function based on the currently selected channel or display. For example, the “D” selector is activated for a predetermined time interval (e.g., two seconds) to activate a delete function. In another example, the “D” button may be selected for a predetermined time to activate a help screen or an additional set mode. In this example, the help screen remains active while button “D” is activated, and the help screen is deactivated (e.g., removed from the display) when the “D” button is released. On many watch faces, the “D” button may show the date, count seconds, or have a custom action/animation associated with it.

The selectors are arranged such that the electronic device accomplishes navigating and selecting content on each channel in a simple manner. An optional fifth selector (e.g., button “E”) may be arranged to provide other functions such as backlighting or another desired function. Other selectors may also be included.

Broadcast Channels

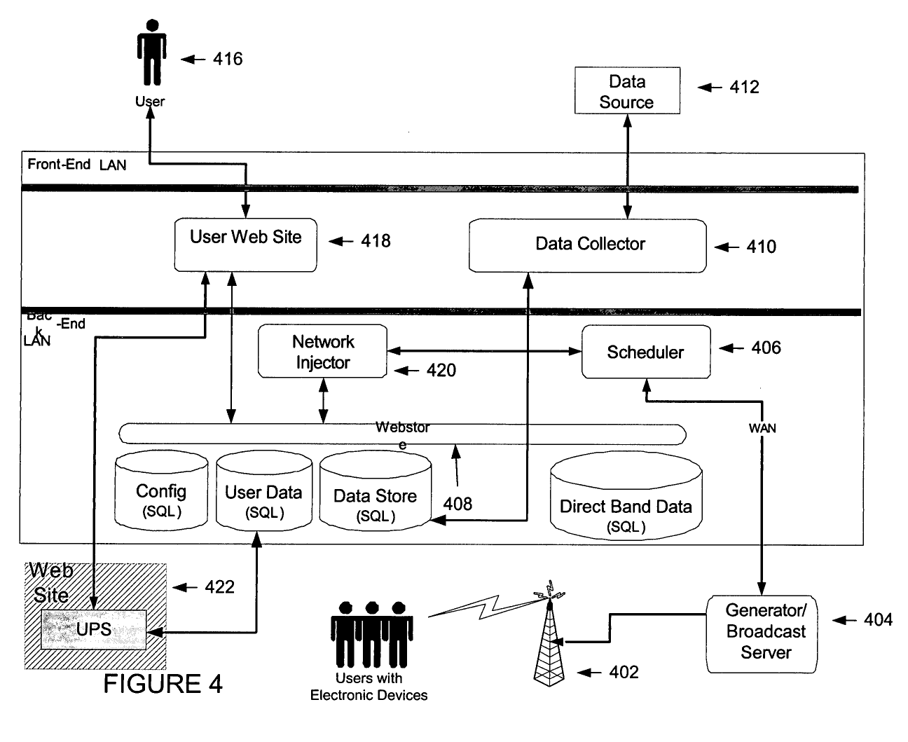

FIG. 4 illustrates a system for delivering and configuring channel information to an electronic device, in accordance with aspects of the invention.

A user, such as user 416, may customize their channels through user web site 418. Using website 418 the user may set options and select information associated with channels to which they have subscribed. For example, the user may select watch faces which are provided to the electronic device. The selected options are stored in a data store, such as webstore 408. Channel information and various options may also be automatically retrieved from a web site to which the user participates in. For example, web site 422 may be the user's home page in which the user has already selected various options customizing their page. These options may be used to populate the options associated with various channels. For example, a user's selected cities may be used in a weather channel, the user's selected theaters may be used in a movies channel, a user's selected stocks they desire to track may be used in a stock channel, and the like.

Data Collector 410 is configured to collect data from one or more data sources, such as data source 412, relating to a channel. For example data collector 410 may collect “retro” watch faces from one data source, and animated watch faces from another data source.

After the data is obtained, the data is encoded and then sent to the device. The data collected by data collector 410 may be stored in a data store, such as webstore 408, for later broadcast.

Broadcast transmitter tower 402 is arranged to provide a communication signal that is configured for reception by users with electronic devices that are located within a service region. Broadcast tower 402 transmits in response to generator/broadcast server 404. Generator 404 may communicate with scheduler 406 via a network communication link. Scheduler 406 is configured to schedule broadcast transmissions relating to channel information. Since watch face data does not change very often, the data is scheduled to broadcast at a low priority level.

Selected services are entered in a database, such as webstore 408 for broadcast transmission at a later time. At the designated time (or time interval) scheduler 406 communicates with broadcast server 404 to begin a transmission sequence of data for the selected services. Broadcast server 404 converts the data to the appropriate format for transmission (i.e. an FM signal) and relays it to broadcast tower 402. In an alternative example, scheduler 406 communicates the selected services to the broadcast server. The broadcast server schedules the time interval for transmission of the selected service.

Each broadcast transmission corresponds to the transmission of one or more frames that are arranged in accordance with a frame protocol. Each frame may include multiple messages, where some messages are public broadcast (aka “global” or “shared” messages), while other messages are client specific messages (aka “personal” or “private” messages). Each frame includes a table of contents that indicates the extent of messages that are found within the next transmitted frame. Every client that is located within the designated service region receives the shared and personal messages. Personal messages, however, may only be decoded by a single account. A user may have multiple devices registered under a single account.

Each frame includes a header, a table of contents, and a message payload that includes the content for one or more selected services. The header also includes other information such as authentication data, identified service region, language, available stations for the identified service region, frame number, and time stamp. Control information may also be included in one of the headers to indicate broadcast conditions such as a change in available channels, an assignment of a service region to a particular wireless client device, and an assignment of a particular channel (frequency). In one example, each frame includes a change counter in one of the headers to indicate a change has taken place in the system. Wireless client devices (clients) may use the change counter to determine when to initiate a failover (when a broadcast tower becomes unavailable).

Client devices can determine the current service region based on information that is included in the broadcast transmissions. The time zone can be determined based on the current service region such that the client device can adjust any time related information. Moreover, the time and date functions of the client device may be synchronized based on information that is included in the broadcast transmissions.

When a new configuration message is received by a device for adding/removing faces, the old faces are removed and the new watch faces begin downloading. According to one embodiment, when possible, the watch faces are packaged as three faces that do not include a bitmap and two that include a bitmap.

Downloadable Watch Faces

Watch faces are broadcast over a communication signal and downloaded to a user's device. Using the device, users can quickly change the current watch face. The user may customize the watch faces they receive on their device. For example, the user may select from a list of available watch faces from a web site. Additionally, a mystery watch face may be downloaded on a recurring basis to the user's device. The user preferences and watch faces may be provided as information that is retrieved from broadcast transmissions such as described herein. The program code associated with each watch face that is delivered to the user's device may be different for each watch face.

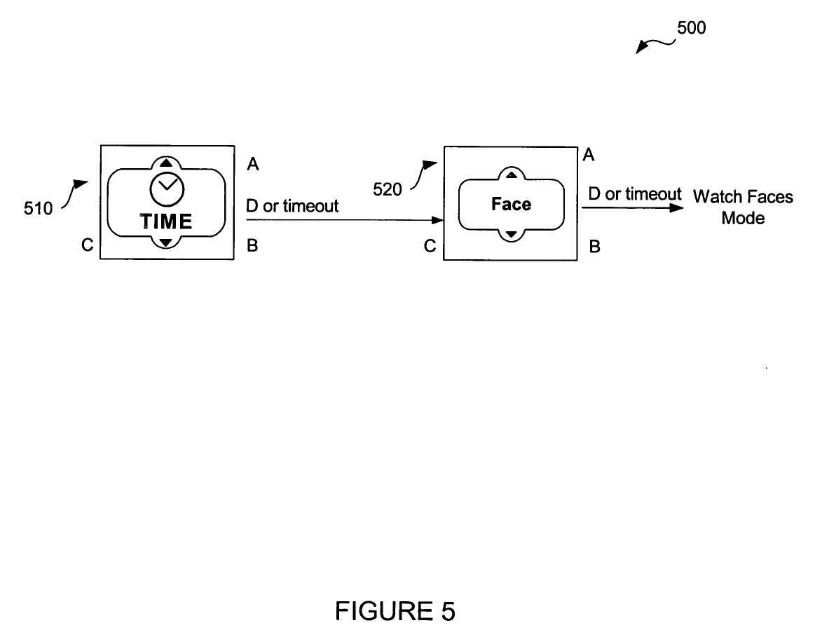

FIG. 5 shows a face operating mode associated with a time channel, in accordance with aspects of the invention. Time channel splash-screen 510 may be displayed when the time channel is initially selected. After the time channel is selected, one of the available modes is activated by the expiration of a timeout period (e.g., two seconds) without user interaction, or by activation of the “D” or “enter” selector. The channel splash can be activated from any one of the mode splash screens by activation of the “C” selector (See FIG. 3).

A mode splash-screen is displayed whenever the mode is changed on the device. In one example, the mode may be changed by selective activation of the next and previous selectors (e.g., the “B” and “A” buttons) when any mode splash screen is active. The mode splash screen may be dismissed via a timeout condition or by activation of the “D” selector (or enter function). Each mode has a series of associated views.

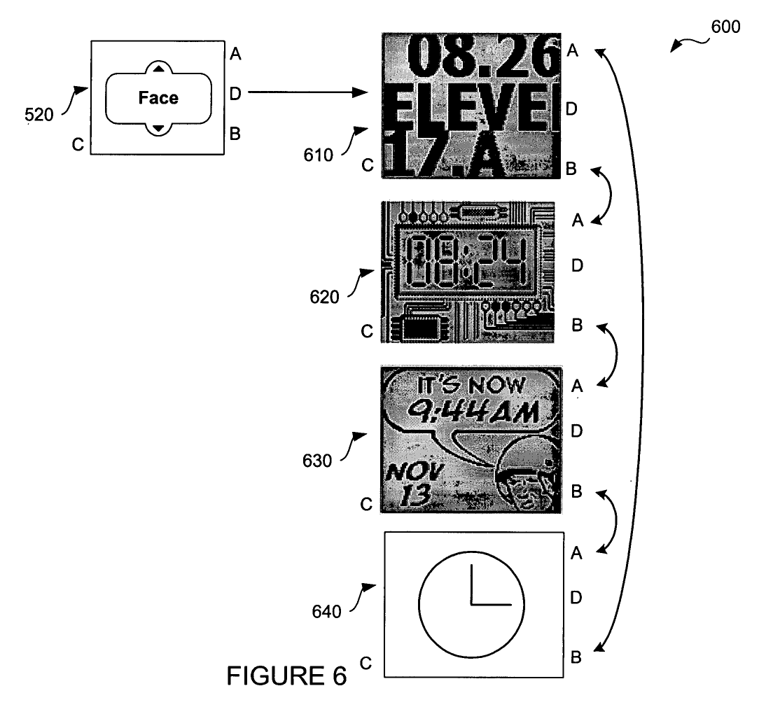

The channel splash-screen is dismissed after a mode is activated. When the face mode is activated, face splash screen 520 may be displayed. After the face splash-screen is dismissed, the device enters the face mode. Generally, the face mode of the time channel includes many display views that correspond to the available watch faces on the device (See FIG. 6 and related discussion).

While in one of the time modes, the user may select the “C” button to bring up the splash screen for the current mode. The user may then use the “A” or “B” buttons to move forward or backward through the available modes. The mode may be either selected actively by pressing the “D” button while the mode splash screen is being displayed or passively by waiting a predetermined period of time while the mode splash screen is being displayed.

Face Mode

FIG. 6 illustrates a face mode 600, in accordance with aspects of the invention. Generally, the face mode is the default mode for the time channel and displays the available watch faces to the user for their selection. The watch faces that are downloaded include code for controlling their behavior and functionality and may also include graphics, such as bitmaps, for display. In the face mode, users can locate a watch face by scrolling through the available faces on the user's device.

The watch faces are arranged in a circular fashion. In other words, selecting the “next” button (button “B”) from the last watch face selects the first face and selecting the “previous” button (button “A”) from the first watch face selects the last watch face.

A watch face may be selected by either waiting a predetermined time, or selecting the “D” button selects the watch face for the device. In other words, selecting the “D” button displays the selected watch face when the time channel is selected. Displays 610-640 illustrate exemplary watch faces. Many other watch faces may be designed and provided to the user.

The “A” (previous) button navigates to the previous watch face. The “B” (next) button navigates to the next watch face.

According to one embodiment, the electronic device may store up to five downloadable watch faces. The watch may be configured to store more or less faces.

According to one embodiment, the management of the watch faces on the device is performed from a web site. According to another embodiment, the user may perform limited operations on the watch. For example, the user may delete or add a watch face from the watch.

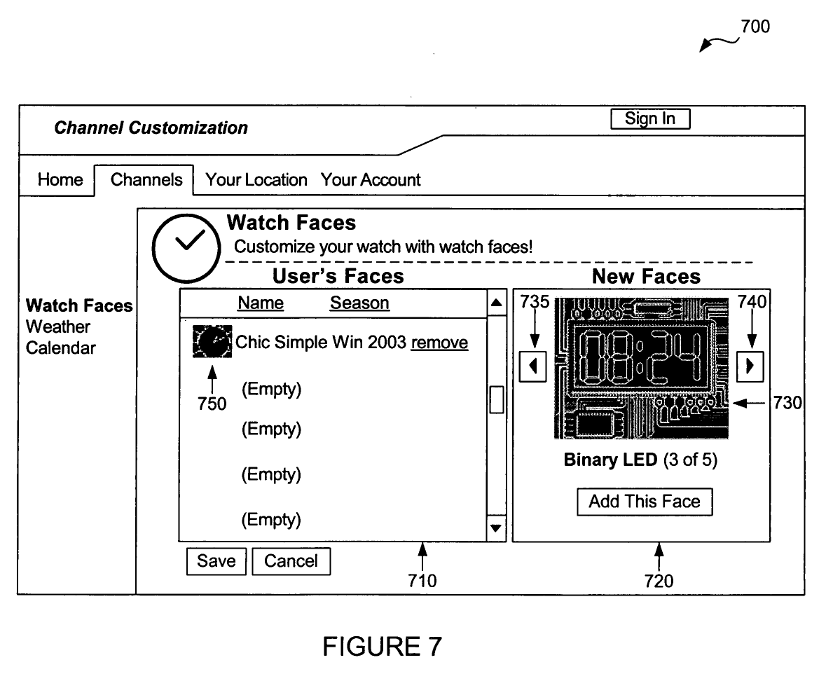

FIG. 7 illustrates a user interface for managing watch faces, in accordance with aspects of the present invention. Generally, the web user interface (UI) manages the watch faces the user currently has available on their electronic device. A service associated with the website keeps track of the faces on each of the user's devices.

When the user first visits downloadable watch faces configuration page 700, the watch faces list box control 710 has empty slots which all display “(Empty)” After a watch face has been added, a preview icon (750) is displayed next to the name of the watch. The time the watch was available for download is displayed under the season column. A remove link is also provided to remove the watch face from the electronic device.

The preview icon (750) shows a small graphic version of the watch face currently on the user's watch. The preview icon is displayed even if the watch face is no longer being broadcast. In other words, all of the watch faces on a user's device may not always be available for download.

The season column lists the season that the face was available for download. If the face is currently available for download, the column says “current.” According to one embodiment, the seasons include winter, spring, summer, and fall. According to another embodiment, the month the watch face is downloaded is displayed. Other dates may also be used.

The remove link provides the user an easy way to remove the watch face from their watch face lineup. When a watch face is removed, the other watch faces within the list slide up the list to fill the space left by removing the watch face.

New Faces Control 720 shows new faces that are currently available for download. A limited number of faces are available for download at any one particular time. According to one embodiment, five watch faces are available for download at any one time. Allowing a limited number of watch faces to be downloaded helps to control the amount of bandwidth required to transmit all of the different watch faces. According to one embodiment, the watch faces are updated each season. When there are no bandwidth constraints, the number of watch faces available for download may be unlimited. Other time periods may also be used. For example, the new faces may be made available weekly, monthly, quarterly and the like. New faces may also be made available around holiday periods. Selecting left arrow 735 or right arrow 740 allows the user to scroll through the currently available watch faces. The list is circular so selecting the left arrow while on the first watch face moves to the last watch face and selecting the right arrow from the last watch face moves to the first watch face. During the preview of the watch face, a title of the watch face is displayed along with its position within the list of new faces. According to one embodiment, the previews are animated so that the user is able to experience the watch face changing. When the user decides to add a watch face, they can select the Add This Face button.

Changes made to the User's Faces list applied when the user clicks the “Save” button on the bottom of the page. If the user clicks “Cancel,” then all of the old faces are retained and no updates are made to the list.

When the user changes a watch face a configuration message is sent to the user's electronic device. Generally, when a watch face is to be added, the device determines the channel from which to download the watch face.

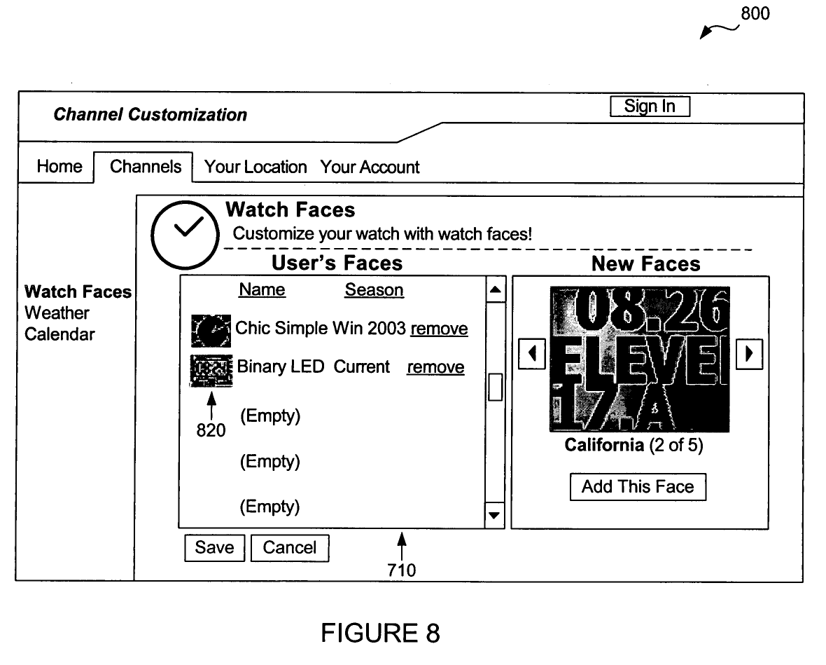

FIG. 8 illustrates a user adding a watch face, in accordance with aspects of the present invention. As illustrated within the figure, the Binary LED watch face displayed in the New Faces section of FIG. 7 was added to the user's watch lineup. Once added, list box 710 is updated with the newly added watch. A preview (820) of the newly added watch is displayed next to its name. Under the season column, “Current” is displayed indicating that the watch face is currently available. During the time the watch is currently available the user may remove the watch face and download it again at a later date. According to one embodiment, once the watch is out of season (i.e. no longer available) the watch face can not be downloaded.

When changing seasons, the last season's watch faces are continued to be broadcast for a period of time after the end of the season to accommodate any users who signed up for the face on the last day of broadcast before the change of seasons. According to one embodiment, the scheduler instructs the server to broadcast last season's faces for one week past the end of the season. The last season's faces are broadcast at a slightly lower priority than the current watch faces broadcast priority.

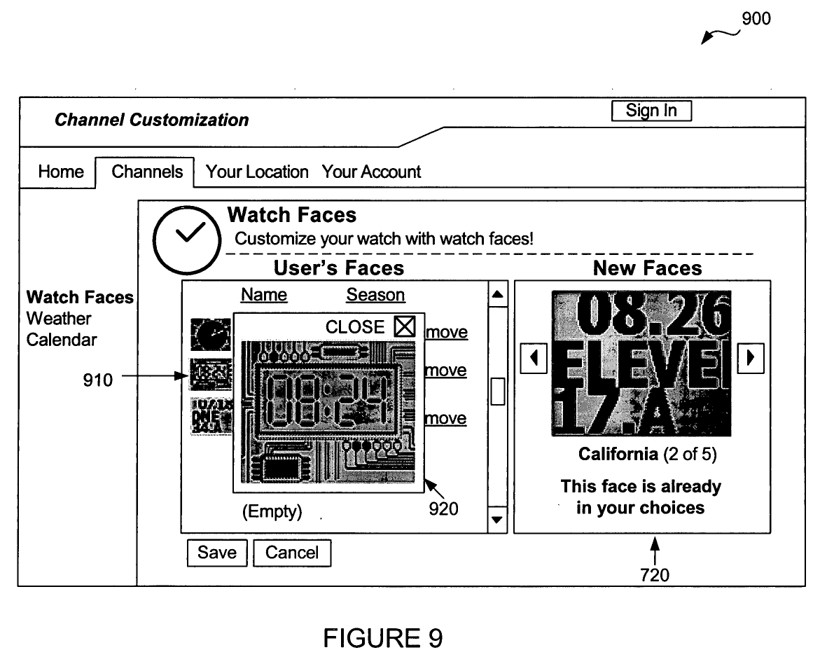

FIG. 9 illustrates hovering over a preview watch face icon, in accordance with aspects of the present invention. When the user hovers over one of the preview icons for a predetermined period of time, the full size image of the watch face is displayed. In the present example, the user is hovering over the Binary LED control preview icon 910. In response to the hovering, full size image 920 is displayed of the Binary LED watch face. This image may be closed by selecting the close box on image 920. Alternatively, the image may be closed when the user stops hovering over the preview icon.

Referring to new faces display 720 when the user is displaying a watch face that is already on their device, the add button is removed and a message indicating that the watch face is already on the user's device is displayed.

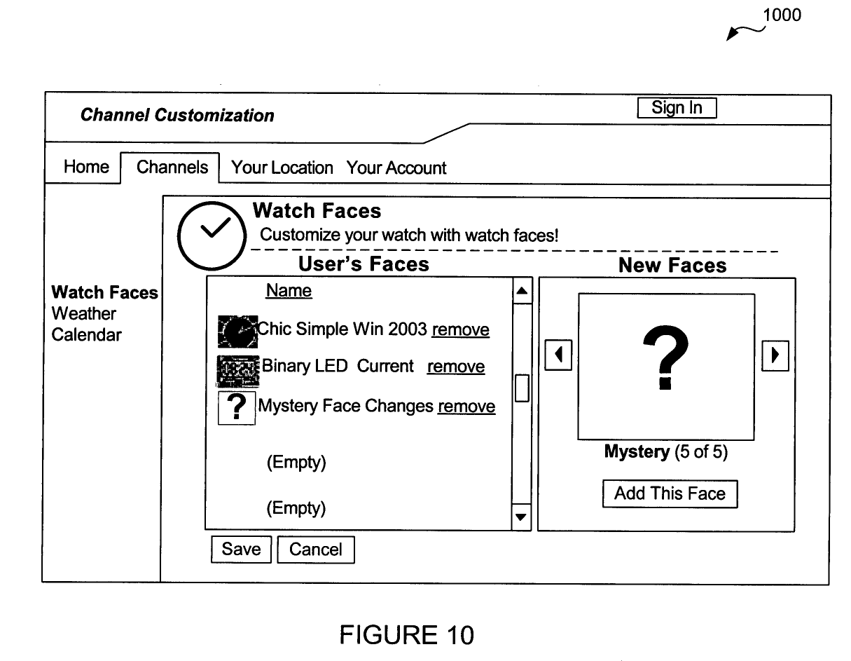

FIG. 10 illustrates subscribing to a mystery watch face, in accordance with aspects of the present invention.

The user may choose to have a mystery watch face downloaded to their device. Occasionally, such as each month, a “mystery face” may be provided to users devices. According to one embodiment, instead of displaying the mystery watch face, the mystery watch face appears as a question mark in the preview. The title listed in the list box when the mystery watch face is added is: “Mystery Face.” If a user subscribes to the mystery face by selecting the “Add This Face” button on screen 1000, then the device receives the new mystery face whenever it changes. According to one embodiment, whenever a new mystery face is received by the device, any mystery face currently on the device is removed from the device.

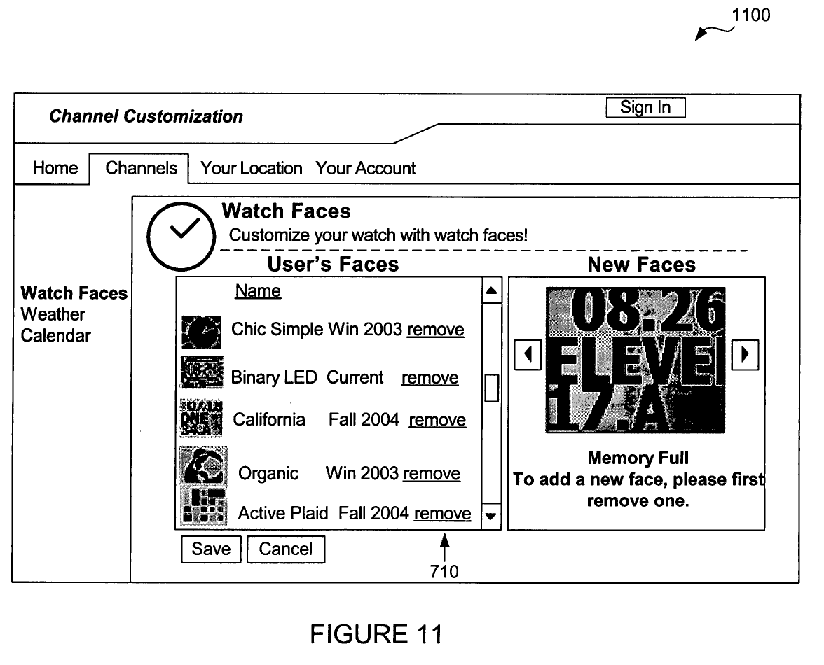

FIG. 11 illustrates an exemplary display showing that memory is full, in accordance with aspects of the invention. When the user has reached the maximum number of watch faces allowed, watch faces may be previewed but not added to the device until a watch face is removed from list box 710. The Add button is replaced by an “error” message that says: “Memory Full. To add a new face, please first remove one.”

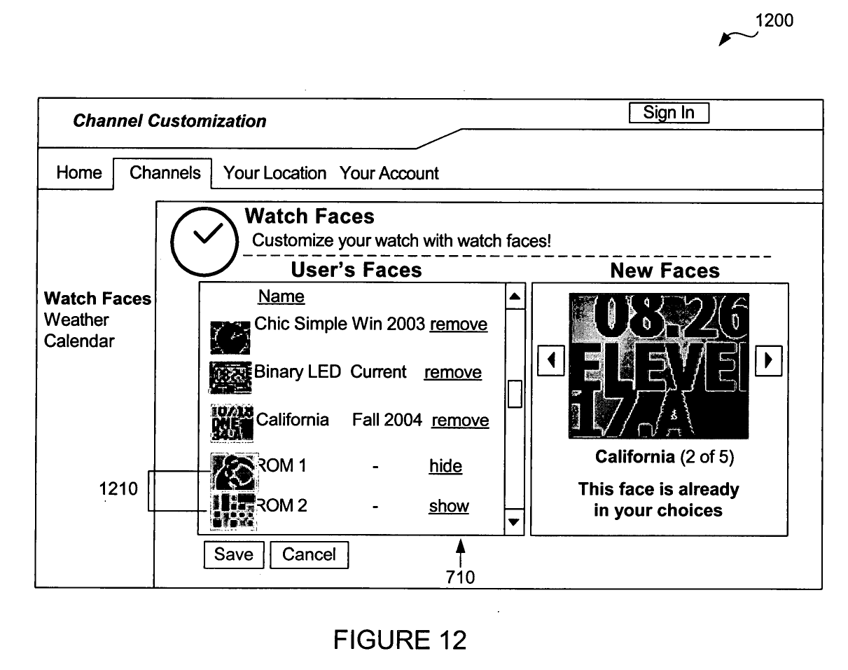

FIG. 12 illustrates ROM faces and downloadable watch faces, in accordance with aspects of the invention.

According to one embodiment, the default watch faces that are stored in the ROM of the device appear in the list of watch faces that are downloaded to the watch. Alternatively the downloadable watch faces may appear in a separate lineup.

Referring to list box 710, the downloadable watch faces appear in the same faces lineup as the ROM faces. The downloadable faces all appear grouped together before the ROM faces (1210) in the circular list. The downloadable watch faces may also appear grouped after the ROM faces, or in some other order. The user may set an option of whether to show or hide the ROM face on the device. For example, the watch face stored in ROM 2 is set to be hidden from the user on the device. In other words, when the user is selecting the watch face from the time channel under the face mode, the watch face in ROM 2 will not be shown. Selecting the hide link hides the watch face and selecting the show link shows the watch face.

According to one embodiment, all watch faces may not be available to every type of device. For example, one device may receive certain faces while another device may receive other faces.

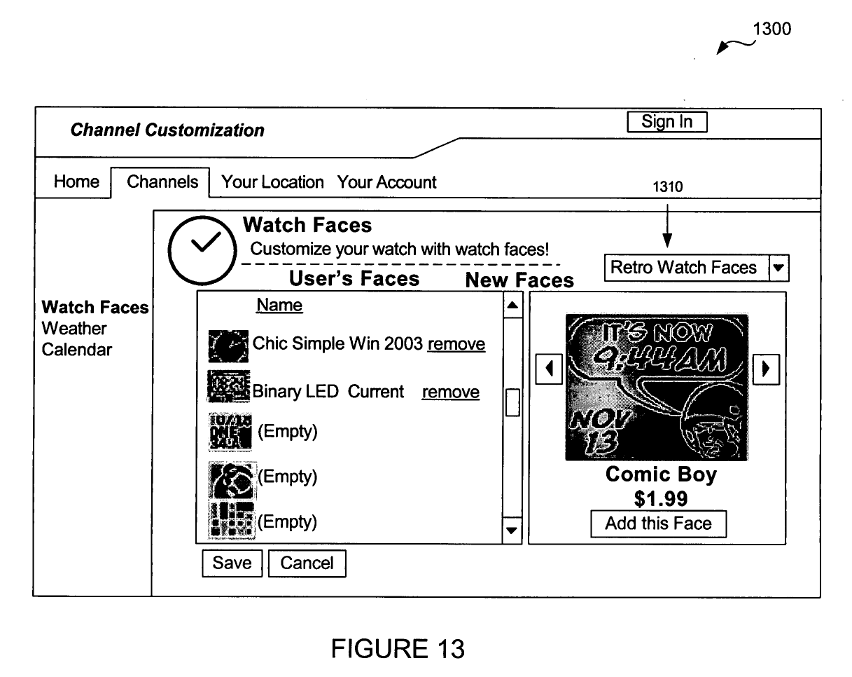

FIG. 13 illustrates purchasing watch faces, in accordance with aspects of the invention. As illustrated within the figure, a user may purchase watch faces. A dropdown list 1310 is provided from which the user may select the style of watch faces they would like to preview. The watch faces may be categorized in any manner. For example, the watch faces may be categorized to a period of time in which they were released, the type of watch face, the style of the watch face, and the like. In the present example, the user selected “Retro Watch Faces.” If the user desires to purchase a watch face, selecting the “Add this Face Button” will add this to the list of user's faces and a charge will be made to the user for the price of the watch face. The user may be prompted to enter billing data or other information in order to complete the transaction. An option may also be provided to allow the user to use the watch face on their device for a limited time period before purchasing to try out the watch face.

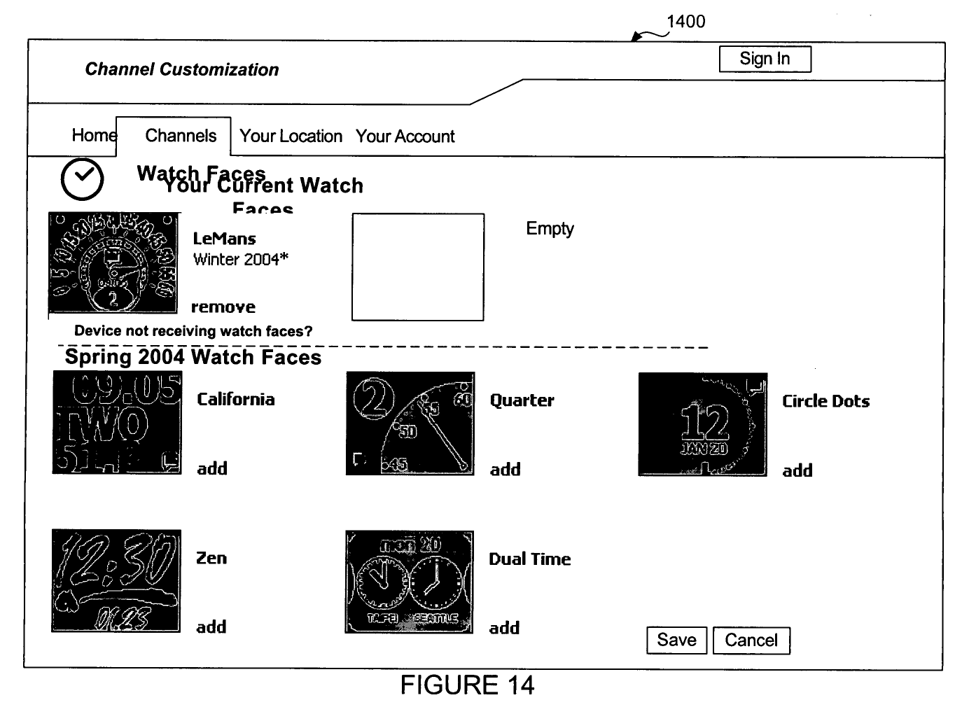

FIG. 14 illustrates another user interface for managing watch faces, in accordance with aspects of the present invention. As illustrated, interface 1400 displays the user's currently selected watches followed by available watches that the user may add. According to one embodiment, the user may select up to two season watches at one time. According to another embodiment, the user may select up to the number of the available slots on the device. If the user were to have one of the Spring 2004 watch faces already on their device, then the corresponding watch face in the Spring 2004 section would be displayed greyed out indicating to the user that the watch face is not selectable. Many other interfaces may be implemented to manage the watch faces on the user's device.

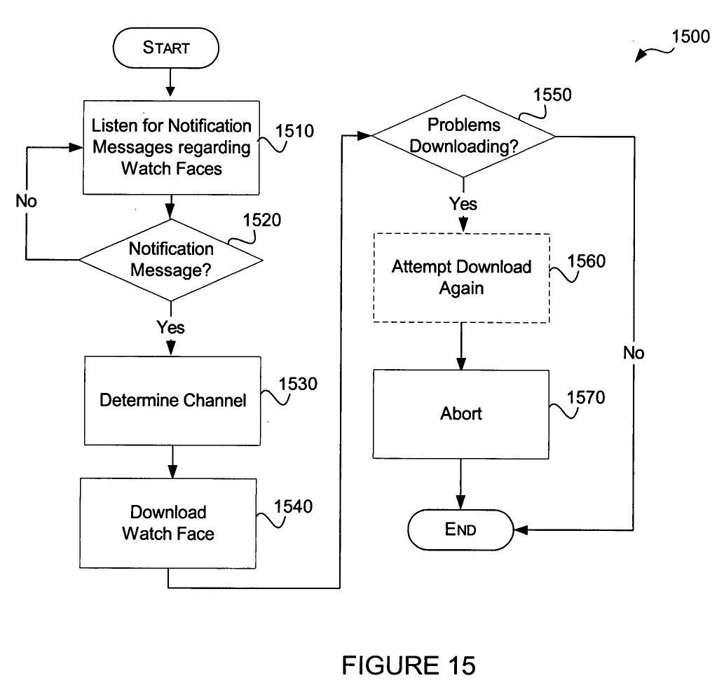

FIG. 15 illustrates a process flow for receiving a new watch face, in accordance with aspects of the present invention. After a start block, the process flows to block 1510 where the device listens for a notification messages regarding adding a new watch face. According to one embodiment, the device listens on a predetermined channel for information regarding watch faces.

Moving to decision block 1520, a determination is made as to whether there is a notification message relating to a new watch face. When there is not a notification message, the process returns to 1510 to continue to listen for notification messages. When there is a notification message, the process transitions to block 1530 where the device determines the channel number for the new watch face download. The notification message includes the channel that the watch face will be broadcast on.

Moving to block 1540, the device downloads the watch face from the designated channel. When the watch begins to download a new watch face, the watch face name being downloaded appears in a “Receiving” channel on the electronic device. When the new watch face has completed downloading to the device, the new watch face appears in the faces view of the time channel. The user may also be notified when the new face has been downloaded. The notification may be through a message or through an audible notification.

Flowing to decision block 1550, a determination is made as to whether there are any problems downloading the watch face. When there are not any problems with the download, the process steps to an end block and returns to processing other actions.

When there is a problem downloading the watch face, the process steps to optional block 1560 where the download may be attempted again. According to one embodiment the download is attempted three times before aborting. After that, the user can go back to the web page (FIG. 14) and select the “Device not receiving watch faces?” link to have the device attempt to download the watch face again.

Moving to block 1570, the download is aborted. According to one embodiment, the download is automatically aborted after a predetermined amount of time has expired. This helps to conserve battery life and memory on the device.

When a watch face download has been aborted, the user may attempt to download the watch face again. As long as a watch face is available for download, the user may access the watch face web page and select a “resend” link associated with the watch. The process then steps to an end block and returns to processing other actions.

Operating Environment

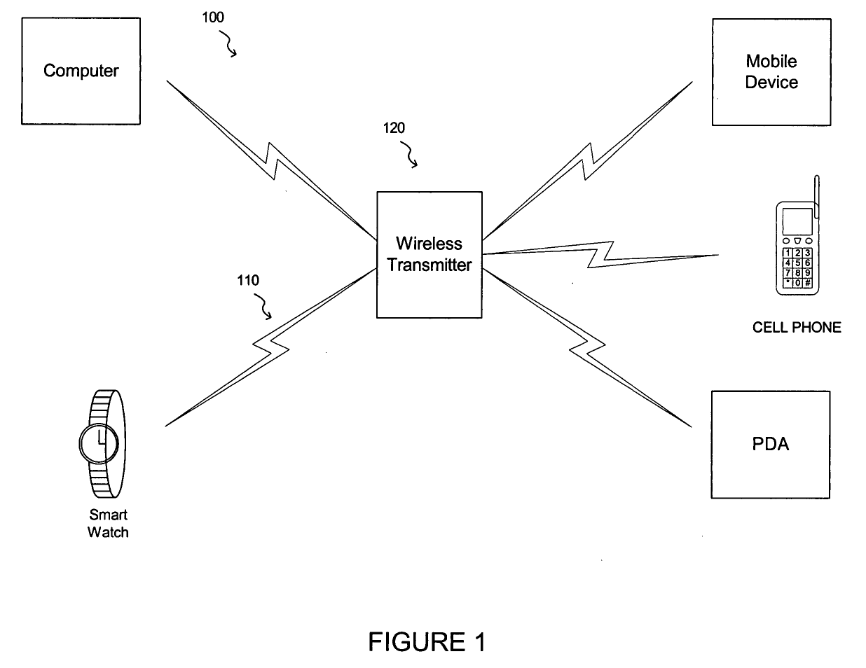

FIG. 1 illustrates an example operating environment for the present invention. As illustrated, operating environment 100 includes wireless transmitter 120 that is responsible for delivering content to wireless devices. According to one embodiment, the wireless transmitter may include a cellular tower that is used to communicate with mobile devices, such as cell phones, notebooks, pocket PCs, long-distance communication links, and the like. According to another embodiment, the wireless transmitter may include an FM transceiver that broadcasts signals over communication channel 110 to the various electronic devices. The FM broadcast may be any number of types including but not limited to: a standard FM transmission, a sub-carrier FM transmission, or any other type of FM transmission as may be desired. Example electronic devices that have an FM receiver or transceiver may include a desktop computer, a watch, a portable computer, a wireless cellular telephone (cell phone), and a personal data assistant (PDA). The electronic devices are arranged to receive information from the wireless broadcast.

Some example electronic devices that may include an electronic system arranged to operate according to the interaction model are illustrated in FIG. 1. Each of the electronic systems receives messages/information over the communication channel.

According to one embodiment, each broadcast transmission corresponds to the transmission of one or more frames. Each frame may include multiple messages, where some messages are public broadcast (aka “global” or “shared” messages), while other messages are client specific messages (aka “personal” or “private” messages). Every client that is located within the designated service region may receive shared messages, while a single client may decode a private message.

Electronic devices (e.g., a wireless watch device) receive message packets according to shared and private messages that are directed to the client device. Message packets are organized in groups according to logical slot (or channel) entry numbers. For example, a particular electronic device is configured to receive a selected group of channels from the available channels. The message packets associated with each of those channels is received, processed, and stored in the client device. The stored message packets can be reviewed using a user interface that employs an interaction model, in accordance with the present invention.

Example channels include: a sports channel, a time channel, a messages channel, a calendar channel, a weather channel, a stocks channel, a news channel, and a movies channel. Messages associated with each channel include message content that is based on the particulars of the channel. For example, the sports channel may include results of games played involving teams the user in which the user desires to follow.

FIG. 2 is a schematic diagram illustrating functional components of an illustrative electronic device that may be used to interact with channel content, in accordance with aspects of the invention. Electronic device 200 includes processor 260, memory 262, display 228, and user interface 232. Memory 262 generally includes both volatile memory (e.g., RAM) and non-volatile memory (e.g., ROM, Flash Memory, or the like). Electronic device 200 may include an operating system 264, such as the Windows CE operating system from Microsoft Corporation or another operating system, which is resident in memory 262 and executes on processor 260. User interface 232 may be a series of push buttons, a scroll wheel, a numeric dialing pad (such as on a typical telephone), or another type of user interface means. Display 228 may be a liquid crystal display, or any other type of display commonly used in electronic devices. In one example, display 228 may be touch-sensitive that would act as an input device.

One or more application programs 266 are loaded into memory 262 and run on the device. Examples of application programs include watch face programs, calendar programs, movie programs, time programs, and so forth. Electronic device 200 also includes non-volatile storage 268 that is located within memory 262. Non-volatile storage 268 may be used to store persistent information which should not be lost if electronic device 200 is powered down. Applications 266 may use and store information in storage 268, such as sports content used by a sports application, appointment information used by a calendar program, and the like.

Electronic device 200 includes power supply 270, which may be implemented as one or more batteries. Power supply 270 might further include an external power source, such as an AC adapter or a powered docking cradle that supplements or recharges the batteries.

Electronic device 200 is also shown with two types of external notification mechanisms: LED 240 and audio interface 274. These devices may be directly coupled to power supply 270 so that when activated, they remain on for a duration dictated by the notification mechanism even though processor 260 and other components might shut down to conserve battery power. LED 240 may be programmed to remain on indefinitely until the user takes action to indicate the powered-on status of the device. Audio interface 274 is used to provide audible signals to and receive audible signals from the user. For example, audio interface 274 may be coupled to a speaker for providing audible output and to a microphone for receiving audible input, such as to facilitate a telephone conversation, or as a user interface using voice recognition. In another example, a vibration device (not shown) can be used to give feedback to the user such as for alerting the user of a newly arrived content. Electronic device 200 can control each alert mechanism separately (e.g., audio, vibration, as well as visual cues).

Electronic device 200 also includes a communication connection, such as radio interface layer 272, which performs the function of receiving and/or transmitting radio frequency communications. Radio interface layer 272 facilitates wireless connectivity for electronic device 200. Transmissions to and from radio interface layer 272 are conducted under control of the operating system 264. In other words, communications received by radio interface layer 272 may be disseminated to application programs 266. The communication connection may also be a direct connection. For example, a user could connect the device to a USB port and download watch faces.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are included within the scope of computer readable media.

In one example of the present invention, electronic device 200 is a mobile electronic device such as a watch device that includes a wireless interface. An exemplary watch device is shown in FIG. 3.

The above specification, examples and data provide a complete description of the manufacture and use of the composition of the invention. Since many embodiments of the invention can be made without departing from the spirit and scope of the invention, the invention resides in the claims hereinafter appended.

1. A method for receiving and interacting with downloadable watch faces on a mobile electronic device, comprising:
receiving a watch face through at least one of the following: a broadcast directed to many electronic devices; a direct connection; and a peer connection from another device that has the watch face;
storing the watch face on the electronic device;
associating the watch face with a time application on the electronic device; and
displaying the watch face on a display of the electronic device.

2. The method of claim 1, further comprising selecting the watch face from a plurality of watch faces that are stored on the mobile electronic device.

3. The method of claim 1, wherein selecting the watch face from the plurality of watch faces further comprises selecting a face mode on the mobile electronic device.

4. The method of claim 2, further comprising receiving an input from a selector on the mobile device indicating the watch face to be selected.

5. The method of claim 2, wherein receiving the watch face through the broadcast, further comprises determining a channel the watch face is to be broadcast on.

6. The method of claim 5, wherein determining the channel the watch face is to be broadcast on, further comprises receiving a configuration message including the channel information.

7. The method of claim 1, further comprising selecting a watch face on a web site to be broadcast to the mobile electronic device.

8. An apparatus for receiving and interacting with downloadable watch faces on a mobile electronic device, comprising:
a data store;
a communication device configured to receive a watch face through at least one of the following: over a broadcast that is directed to a plurality of mobile electronic devices and store the watch face in the data store; a direct connection; and a peer connection from another apparatus that includes the watch face;
a display;
a user interface that includes a selector; and
an electronic system that is arranged to interact with the user interface, the data store, the communication connection, and the display, wherein the electronic system is configured to:
select a current watch face when a time channel is activated; and
display the current watch face on the display.

9. The apparatus of claim 8, wherein the electronic system is further configured to select the current watch face from a set of watch faces stored on the apparatus in response to the selector.

10. The apparatus of claim 9, further comprising determining the set of watch faces to store on the apparatus in response to user preferences.

11. The apparatus of claim 9, wherein receiving the watch face over the broadcast, further comprises determining a channel the watch face is to be broadcast on.

12. The apparatus of claim 11, wherein determining the channel the watch face is to be broadcast on, further comprises receiving a configuration message including the channel information.

13. A system for receiving and interacting with downloadable watch faces on a mobile electronic device, comprising:
a broadcast device configured to broadcast a watch face to a plurality of mobile electronic devices at the same time;
a mobile electronic device, having:
a data store;
a communication connection configured to receive the broadcast including the watch face and store the watch face in the data store;
a display;
a user interface that includes a selector; and
an electronic system that is arranged to interact with the communication connection, the user interface, the data store and the display, wherein the electronic system is configured to:
select a current watch face; and
display the current watch face on the display.

14. The system of claim 13, further comprising in response to the selector, selecting the watch face from a plurality of watch faces that are stored on the mobile electronic device.

15. The system of claim 14, wherein receiving the watch face through the broadcast, further comprises determining a channel the watch face is to be broadcast on.

16. The system of claim 15, wherein determining the channel the watch face is to be broadcast on, further comprises receiving a configuration message including the channel information.

17. The system of claim 13, further comprising a web page arranged to receive an input for selecting a watch face to be broadcast to the mobile electronic device.

18. The system of claim 17, wherein the broadcast device is configured to broadcast an FM communication signal.

19. The system of claim 17, further comprising a server configured to receive input from a user to select the watch face to be broadcast.

20. The system of claim 13, wherein the broadcast device is further configured to send a configuration message to the mobile electronic device indicating what watch faces to keep on the mobile electronic device.
